(19) United States
(12) Patent Application Publication
(10) Pub. No.: US 2017/0350100 A1
(43) Pub. Date: Dec. 7, 2017

(54) INTELLIGENT STANDPIPE

(71) Applicant: SKILLTECH CONSULTING SERVICES PTY LTD, Melbourne, VIC (AU)

(72) Inventors: Bruce Atkins, Parkdale (AU); Paul Marsh, Belrose, NSW (AU)

(21) Appl. No.: 15/536,535

(22) PCT Filed: Dec. 17, 2015
(86) PCT No.: PCT/AU2015/050801

§ 371 Date: Jun. 15, 2017

(30) Foreign Application Priority Data
Dec. 17, 2014 (AU) 2014905106

(51) Int. Cl. E03B 9/12; G01D 4/00; G01D 9/00; G01F 15/06

(52) U.S. Cl. CPC E03B 9/12; G01F 15/063; G01D 4/004; G01D 9/005

(57) ABSTRACT

A standpipe (15) for drawing water from a mains water supply. The standpipe includes an inlet 9 having a first coupling (7) configured to enable the standpipe to be connected to a hydrant outlet of the mains water supply and an outlet (5) having a second coupling (23) configured to enable a water delivery hose to be connected to the standpipe. A flow meter (3) measures a volume of water flowing from the inlet to the outlet and a data logger (19) is connected to the flow meter and records the volume of water measured. A global positioning system (GPS) module determines the location of the standpipe (15) when the flow meter 3 detects the water flow and a wireless communication module transmits the recorded volume of water and corresponding GPS location to a central monitoring facility (27).

### FIELD OF THE INVENTION

The present invention relates generally to standpipes for obtaining water from the mains water supply. In particular the invention relates to portable standpipes which incorporate flow meters to enable the volume of water drawn from the mains water supply to be measured and recorded.

### BACKGROUND TO THE INVENTION

Throughout Australia potable water (drinking quality water) is provided to cities and towns by the local water distribution authority. The authority manages a network of pipes that are pressurised and suitably sized to deliver the correct volume of water in each area. This network is collectively referred to in this specification as the ‘mains water supply’, or simply the ‘mains’.

Water from the mains may be used for firefighting purposes, and may be accessed by firefighters via fixed fire hydrant outlets, located throughout the mains network, or in fixed fire sprinkler installations.

The mains water supply is not metered and metering occurs only when water enters a property. All water distribution authorities therefore face a similar problem of ‘unaccountable water loss’. This is water that leaks or is taken from the mains and which the water authority cannot account for. Some of this water loss can be attributed to the use of standpipes.

A standpipe is a portable device which can be attached to a hydrant outlet to provide access to, and draw a controlled flow of water from, the mains water supply. Metered standpipes are used to draw water for many purposes, other than firefighting, including filling large mobile tankers operated by water carting contractors (for domestic supply or dust suppression), temporary supply to construction sites, weed spraying tankers, concrete cutters, road works and cleaning. Metered standpipe sizes are typically based on the size of the standpipe outlet and/or the meter size. The most commonly used standpipe sizes are 25 mm, 32 mm, 50 mm and 65 mm.

A metered standpipe includes a flow meter and every time water is drawn from the mains water supply the user (namely a ‘hydrant permit contractor’, being a person who is permitted to draw water from the mains) is required to maintain a record of the meter reading and enter it into a log book. The completed logs are then sent off to the water authority (being the permit issuing authority), with a photograph of the last meter reading, at the end of each month.

FIG. 1 of the accompanying drawings shows a typical metered standpipe, as used by hydrant permit contractors, showing the fire hydrant connection at the bottom and the flow meter two thirds of the way up the pipe.

As mentioned above, water usage is generally controlled by the issuance of authorised hydrant permits. In other words, each water authority issues a permit allowing authorised contractors to draw water from designated hydrant outlets of the mains water supply system within their control. These hydrant outlets would generally be located within a defined geographical area and may exclude some hydrant outlets within that area if the water pressure at those outlets is known to be low. For example, if the water pressure in a specific area is considered to be too low to allow water to be drawn for non-essential purposes (that is, non-fire fighting purposes), the hydrant outlets within that low pressure area would be deemed to be ‘unauthorised’ hydrant outlets. Each water authority operates its own permit issuing system so there is no single organisation with which contractors can communicate. A contractor which operates across multiple water authorities must obtain a separate permit from each water authority and must keep log books for each water authority.

As an alternative to manually logging water taken from hydrant outlets, an automated system has been developed to enable water usage to be recorded, logged and monitored without operator input. In this regard, WO2014/016625 discloses a ‘telemetric hydrant’ which includes flow measurement, data logging and communications capabilities to enable water drawn from the telemetric hydrant, which is located at a fixed and known position within the mains water supply network, to be monitored at a central location.

In another example, WO2011/022778 discloses a fluid transport truck fitted with a tank. A fill line to the tank includes a flow meter, and a data acquisition device connected to the flow meter records the time and place of each filling event. The GPS location of the water carter's truck at the time of the filling event can be used to determine the location of the specific hydrant from which the water was drawn.

Despite these developments, the applicant has recognised that there remains a need for a more flexible, centralised and automated system to enable water authorities throughout Australia (and in other countries) to manage their own fleet of stand pipes as well as the usage of standpipes owned by others.

Any discussion of documents, devices, acts or knowledge in this specification is included to explain the context of the invention. It should not be taken as an admission that any of the material formed part of the prior art base or the common general knowledge in the relevant art in Australia on or before the priority date of the claims herein.

### SUMMARY OF THE INVENTION

In view of the identified need, one aspect of the present invention provides a standpipe for drawing water from a mains water supply. The standpipe includes:

an inlet having a first coupling configured to enable the standpipe to be removably connected to a hydrant outlet of the mains water supply;

an outlet having a second coupling configured to enable a water delivery hose to be connected to the standpipe;

a flow meter arranged to measure a volume of water flowing from the inlet to the outlet;

a data logger connected to the flow meter and being configured to record the volume of water measured by the flow meter;

a global positioning system (GPS) module configured to determine the location of the standpipe when the flow meter detects water flow; and

a wireless communication module configured to transmit the recorded volume of water and corresponding GPS location to a central monitoring facility.

This ‘intelligent standpipe’ is referred to by the applicant as their SmartPipe™ and will be referred to as such throughout the remainder of this specification.

In one embodiment, the data logger is configured to record the start time of water flow detected by the flow meter, and the wireless communication module is configured to transmit the start time to the central monitoring facility together with the water volume and GPS location. In other embodiments, the finish time and/or duration may also, or instead, be recorded and transmitted to the central monitoring facility.

In another embodiment, the SmartPipe™ includes a water flow switch arranged to detect the presence of water flowing through the standpipe. The water flow switch is connected to the data logger to cause an alarm indication in the event that flow is detected by the water flow switch but is not detected by the flow meter. This alarm indication may be provided at the location of the SmartPipe™ or it may be provided remotely at a central monitoring facility and/or to supervisory personnel via a wireless communication network. The communication could for example be an SMS message, an email, or some other form of notification.

Another aspect of the invention provides a system for monitoring volumes of water drawn from hydrant outlets in a mains water supply. The system includes a plurality of SmartPipe™ intelligent standpipes, as described above, together with a central monitoring facility configured to receive recorded water volume and GPS location data from each standpipe.

In one embodiment, the GPS location data is used to determine the location of the hydrant outlet, within the mains water supply system, from which the water is drawn. This information can then be used to identify the specific hydrant outlet so that it can be displayed on a map of the mains water supply system together with relevant information such as the total volume drawn and the date/time of the water consumption event. The GPS location may also be used to confirm that the hydrant outlet from which the water is drawn is an ‘authorised’ outlet (eg. not having low water pressure). If the outlet is unauthorised then an alarm may be generated at the central monitoring facility. In addition, if the water flow switch detects an alarm condition, an alarm may also be generated at the central monitoring facility. Such an alarm may indicate a malfunction in the SmartPipe™ or it may indicate tampering by the user (the contractor).

A SmartPipe™ intelligent standpipe produced in accordance with the preferred embodiment of the invention can be used in the same manner as a conventional metered standpipe but with the advantage that the contractor does not need to record any water meter consumption readings. This is all done automatically by the on board data logger that is activated as soon as the flow meter starts to register consumption. The start time is logged together with the total volume of water passing though the standpipe. The GPS location is also recorded every time the logger records a reading. This information can then be displayed in real-time on a web-based mapping interface, which allows for immediate verification and queries regarding the standpipe at the time of consumption. The data can also be viewed by the contractor for their internal billing processes.

A key difference between the SmartPipe™ monitoring system and the system described in WO2011/022778 is that all the intelligence is built into the standpipe and is not fixed on the water carter's truck. The means that the SmartPipe™ may be used in connection with any truck within the water cater's fleet of trucks, or it could be used for other purposes and applications which do not necessarily involve a truck. A particular Smartpipe™ could also be associated with a particular individual (perhaps a specific employee of the water carting company) rather than a particular truck, and it can be reassigned if and when needed. The independence of the SmartPipe™ intelligent standpipe also enables new business models to be developed in which a third party provider can deliver water monitoring services to many different water authorities all on the same online platform.

It will be convenient to hereinafter describe the invention by reference to the accompanying drawings which illustrate preferred embodiments. Other embodiments of the invention are possible, and consequently the particularity of the accompanying drawings is not to be understood as superseding the generality of the preceding description of the invention.

### BRIEF DESCRIPTION OF THE DRAWINGS

FIG. 1 is a photograph of a conventional metered standpipe.

FIG. 2A is a photograph of an early prototype of a SmartPipe™ Intelligent standpipe′ in accordance with an embodiment of the invention.

FIG. 2B is a photograph of a second prototype of a SmartPipe™ intelligent standpipe in accordance with an embodiment of the invention.

FIG. 3 is a photograph of component parts of the SmartPipe™ shown in FIG. 2A including a data logger and its enclosure.

FIG. 4 is a schematic diagram of the SmartPipe™ shown in FIG. 2A and FIG. 2B.

FIG. 5 is a schematic diagram of a monitoring system in accordance with a preferred embodiment of the invention utilising the SmartPipe™ shown in FIGS. 2A-4.

FIG. 6 shows an example of a water flow usage graph as may be produced by the SmartPipe™ monitoring system.

FIGS. 7A to 7D show further examples of water usage data and charts covering different periods of time.

FIGS. 8A and 8B show an example of a map (overall and detailed view) depicting a water authority's geographical area and including symbols showing water usage events within a selected time period.

### DESCRIPTION OF PREFERRED EMBODIMENTS

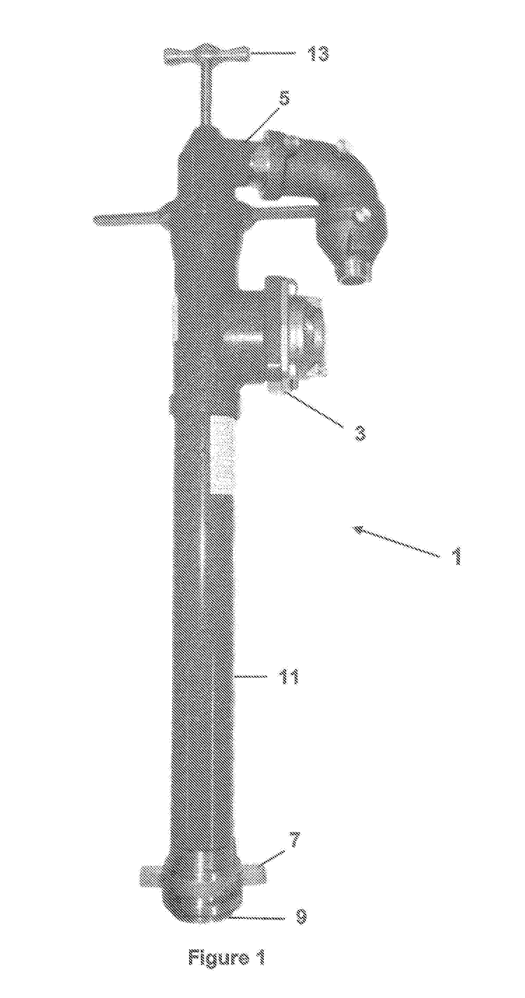

Referring firstly to FIG. 1 of the drawings, there is shown a conventional metered standpipe as produced and sold in Australia by Flotech Solutions Pty Ltd. This product has been in the marketplace for a number of years and is used, in its standard form, by many water authorities, councils and contractors across Australia. The standpipe 1 is fitted with a RMC paddle wheel type flow meter 3, a backflow prevention valve and has dual flow check valves on the outlet 5.

An Australian Standard fire hydrant coupling 7 is used on the base/inlet 9 of the pipe 11. This fitting is a quarter turn coupling and allows connection of the standpipe 1 to a hydrant outlet of the mains water supply. To initiate flow through the standpipe the operator turns a handle 13 on top of the standpipe that has the effect of depressing a spring loaded ball, which is a permanent fixture on a hydrant outlet, thereby allowing the water to flow up the pipe 11. When the water reaches the flow meter 3, located approximately two thirds of the way up the pipe 11, the paddle starts to rotate, thereby incrementing a counter (not shown) on the front face of the flow meter 3.

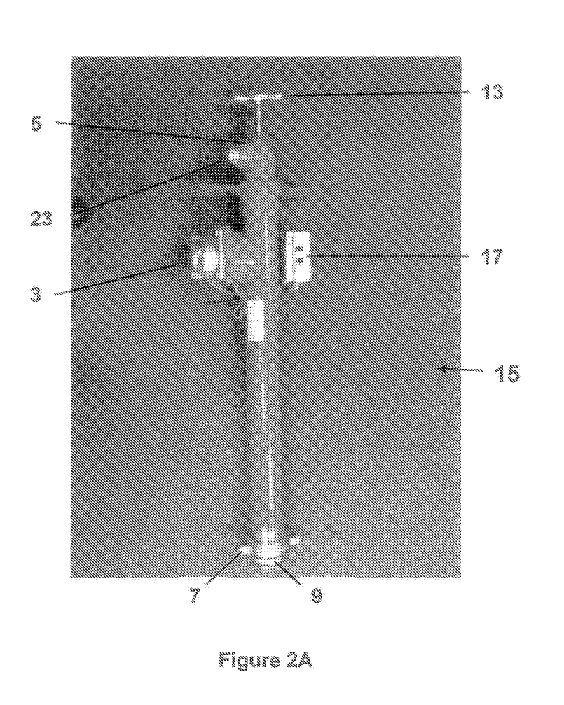

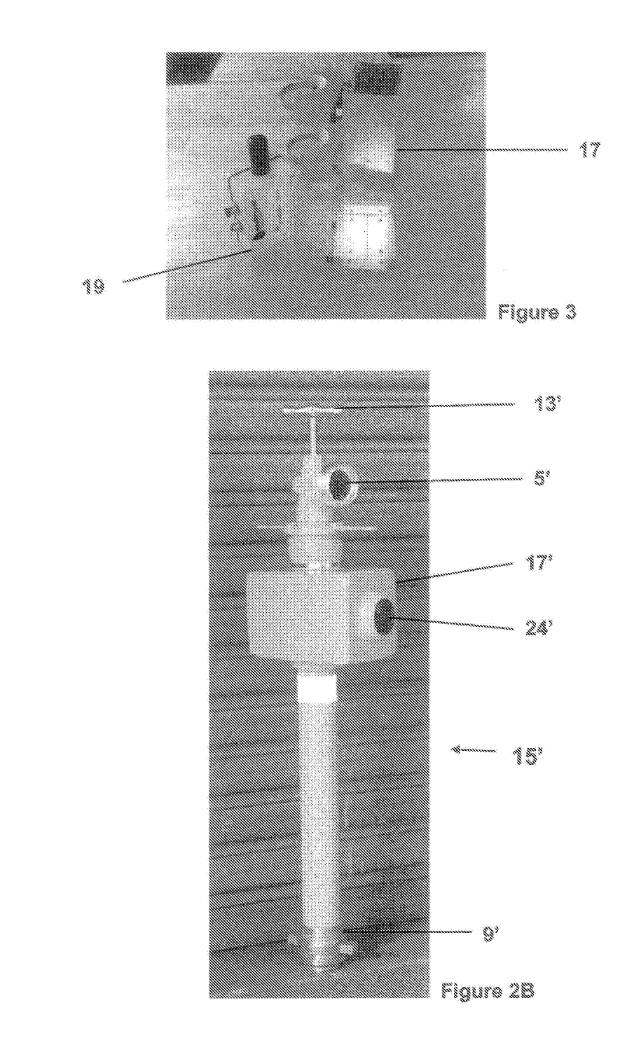

The manufacture of a SmartPipe™ in accordance with the present invention starts off using a conventional metered standpipe of the type shown in FIG. 1. A prototype SmartPipe™ 15 is shown in FIG. 2A and, in this example, includes an enclosure 17 containing a data logger 19, as can be seen in the disassembled unit shown in FIG. 3. In this regard, it will be appreciated that the components of the prototype shown in FIGS. 2A and 3 are not the final version and may eventually take an alternative form. For example, the enclosure 17 may be integrally formed with the body of the SmartPipe™ 15, or it may merely enclose the flow meter 3 as in the later prototype SmartPipe™ 15′ shown in FIG. 2B. This enclosure 17′ was produced in fibreglass so to reduce the overall weight of the SmartPipe™ but still provide a strong, impact resistance enclosure. It also includes a clear window 24′ to enable the counter on the flow meter to be seen.

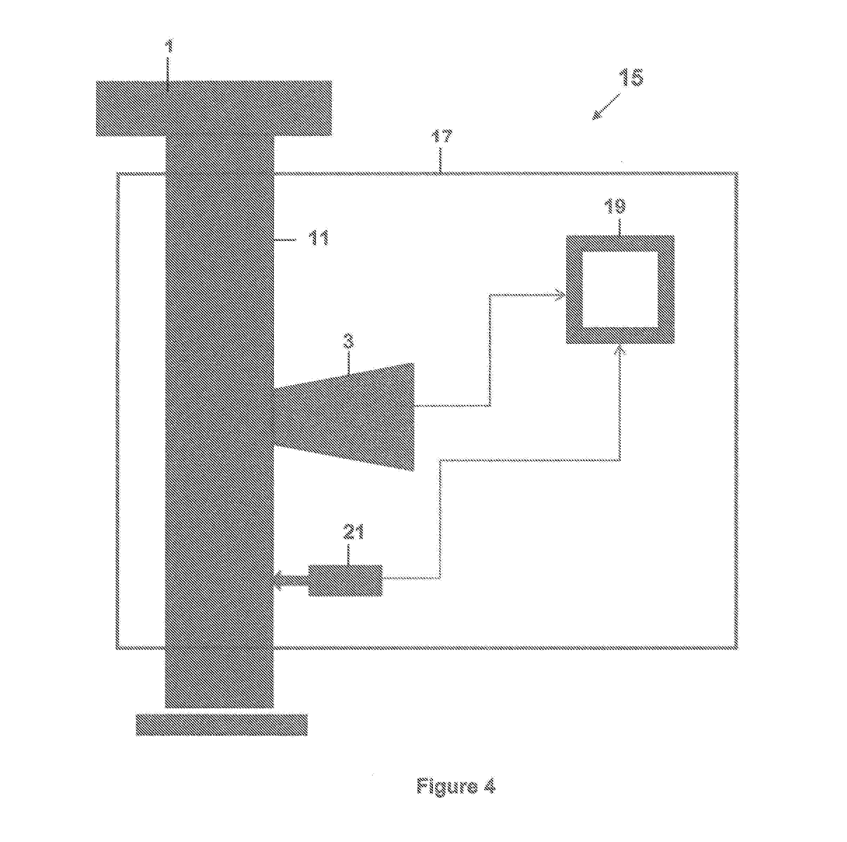

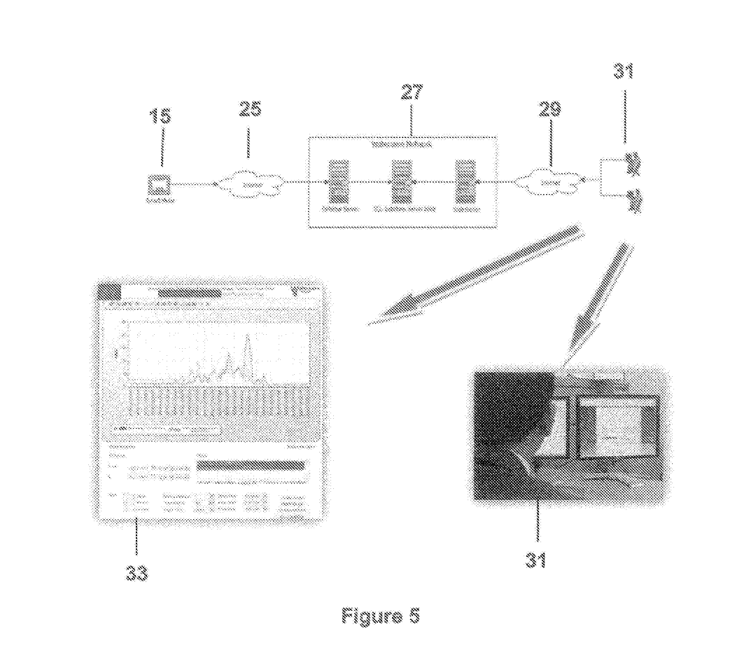

Referring now to FIG. 4, there is shown a schematic diagram of a portion of the prototype SmartPipe™ 15 in which its major components are represented. The prototype SmartPipe™ 15 includes a combination of mostly standard components, as outlined in the following table, but which have been modified and combined in a new and inventive manner.

| Item | | | |
|---|---|---|---|
| No | Item | Supplier | Model No |
| 1 | Stand Pipe | Flotech | SKT1 |
| 17 | Logger | Interfab | WS-ENCLOSURE2/RW |
| | enclosure | | |
| 19 | Data Logger | Watersave Australia | SM-BAT-SP |
| 3 | Flow meter | Apator | WI-65-NK |
| 21 | Water Flow | Kelco | F20/21-SS |
| | Switch | | |

As can be seen from the table, the SmartPipe™ 15 is based on various “off the shelf” components which are readily available from the suppliers noted and which have the model numbers as indicated. For example, the standpipe, at least in the prototype unit, is a model SKT1 which is available in Australia from Flotech Solutions Pty Ltd as mentioned above.

Since the standpipe used in the prototype SmartPipe™ 15 shown in FIGS. 2 to 4 of the drawings is the same as a conventional standpipe 1 as shown in FIG. 1, the same reference numerals have been used in the accompanying drawings to refer to corresponding features of the SmartPipe™ 15.

Accordingly, the SmartPipe™ 15 comprises an inlet 9 having a first coupling 7 configured to enable the SmartPipe™ 15 to be removably connected to a hydrant outlet of the mains water supply. The SmartPipe™ 15 also has an outlet 5 having a second coupling 23 configured to enable a water delivery hose to be connected.

In the prototype, the Apator WI-65-NK flow meter 3 includes a paddle wheel which is arranged to rotate as water flows from the inlet 9 to the outlet 5. In doing so, the flow meter 3 generates electric pulses which are connected to the data logger 19 as shown in FIG. 4. It will be appreciated that any suitable flow meter could be used. The Apator WI-65-NK includes a mechanical counter but a flow meter with a digital counter, a Manuflo MRPU5 flowmeter, could alternatively be used. The main consideration is that it produces electrical pulses which can be counted, or it produces some other form of output which reflects the measured flow rate or volume of water passing through the meter.

The data logger 19 is a modified form of an “Indigo” data logger, Model No. SN-BAT-SP, available from Watersave Australia Pty Ltd. It is a compact robust unit containing a wireless communication module, in the form of a Cinterion PH-8S GPRS modem operating over the 3G cellular network, powered by a 7.2V Lithium Thionyl Chloride battery.

The standard Indigo data logger was modified to also incorporate a global positioning system (GPS) module together with a DG-GPSGSM-CB antenna available from D&G Antennas. To fit within the limited space available in the data logger enclosure, the Circuit board was trimmed back to a bare minimum to allow it to fit within the enclosure. This was done by running the aerial tracks right up to the edge of the board, but without compromising the signal strength (gain). The GPS antenna was glued onto the GSM circular board between the tracks and tested to ensure there was no interference between the GSM and GPS signals. UFL cables were then soldered onto each antenna and terminated at the Cinterion PH-8S modem.

When the data logger 19 receives pulses from the flow meter 3, a process of recording the time, location and number of pulses is initiated. Each pulse is equivalent to a very accurate volume of water. When the water flow ceases, the total number of pulses is counted, thereby equalling a total volume of water delivered through the SmartPipe™. A file is then created containing data relating to the total water volume in litres, the water flow start time, and the GPS location as determined by the GPS module. This unique file is then stored in the data logger until a predetermined upload time is reached. In the initial prototype unit the data is uploaded every 15 minutes such that virtually real-time water usage data is available. Alternatively, the data may be uploaded less frequently, or may be stored temporarily within the data logger if there is a temporary communication failure.

Also shown in FIG. 4 is a water flow switch 21 which is used to confirm that the flow meter 3 is functioning correctly and has not been tampered with by a user. The water flow switch 21 is mounted within the pipe 11 so as to detect the flow of water within the pipe 11. Its output is connected to the data logger 19 such that an alarm is triggered, and stored in the data file created by the data logger, if the flow switch detects water flow but there are no pulses being generated, and hence no water flow being measured, by the flow meter 3. This prevents circumvention of the flow meter reading, and hence possible theft of water from the water mains.

At the predetermined upload time, the data file is transmitted to a central monitoring facility, as is generally shown in FIG. 5.

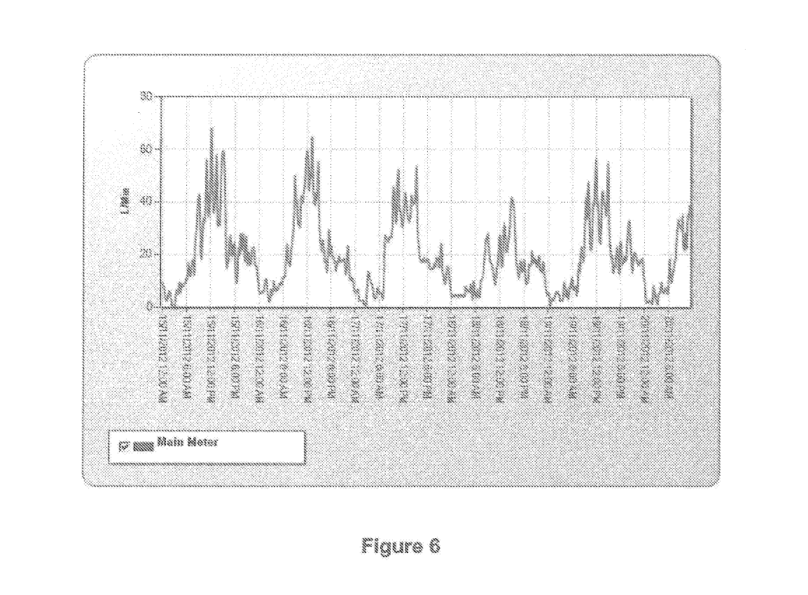

Referring now specifically to FIG. 5, there is shown a representation of a SmartPipe™ monitoring system implemented using the SmartMeter Utility Management Solution (SUMS) operated by Watersave Australia. This system provides an online platform to help organisations manage water and energy usage, and is operated via the company's website www.watersave.com.au. It thus provides a convenient foundation upon which to build the SmartPipe™ monitoring system. To date, the SUMS system has been used to monitor fixed installations and produce reports such as the water usage chart shown in FIG. 6. The provision of GPS location data, from the mobile SmartPipe™ intelligent standpipes, now provides the opportunity to extend the standard SUMS system so as to present SmartPipe™ water usage data in new and useful ways.

Referring again to FIG. 5, each SmartPipe™ 15 is connected via the 3G wireless network 25 to the central monitoring facility 27. This facility includes a Collector server, an SQL Database Server and a Web Server. The Collector is a Java based application designed to receive connection requests from SmartPipes™ 15 remotely, and retrieve logged water usage data continuously at the predetermined upload time intervals. Connections between the collector and the SmartPipes™ are made over the internet on a secure encrypted IP based transmission. Water usage data retrieved from the various SmartPipes™ is interpreted by the Collector and stored in the Database Server. Once usage data has been stored, the Web Server graphically displays the latest data via the Internet 29 to users 31 connected to the Watersave SUMS platform as shown in FIG. 5. Various reports 33 and alarms (such as malfunction or tampering, or withdrawal of water from an unauthorised hydrant outlet) can be automatically generated and can be sent by SMS, email or simply shown on the webpage.

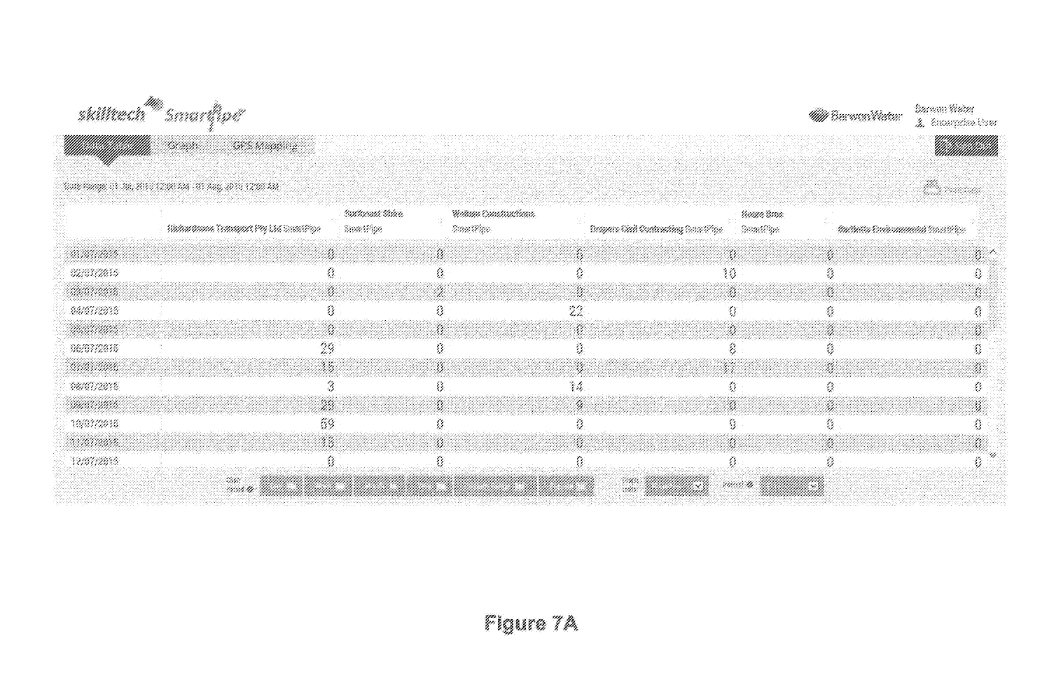

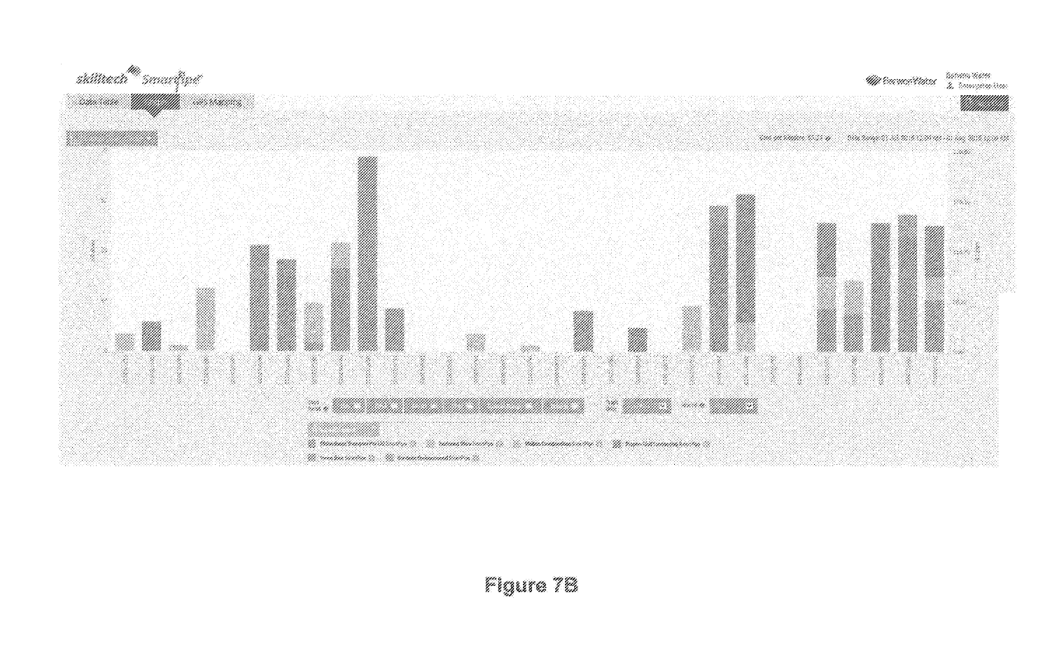

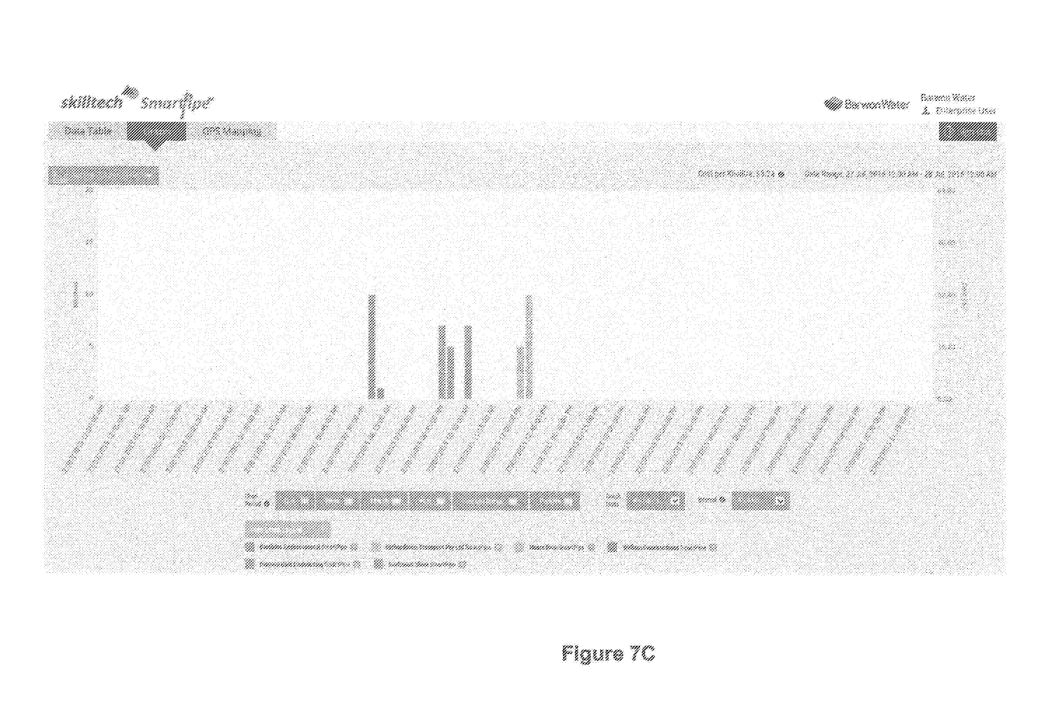

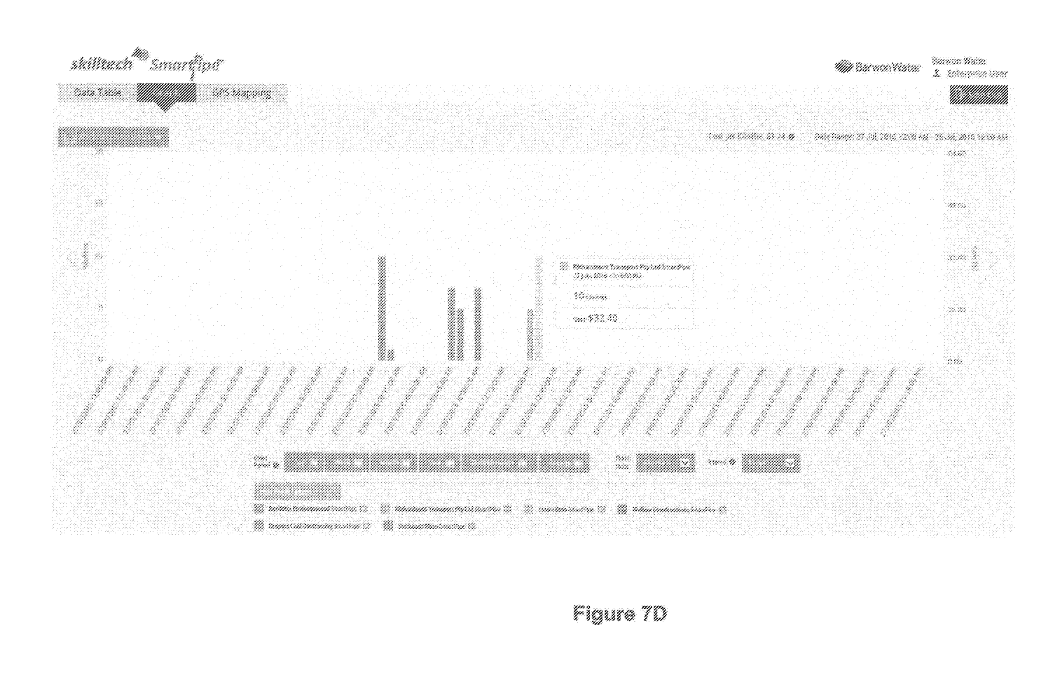

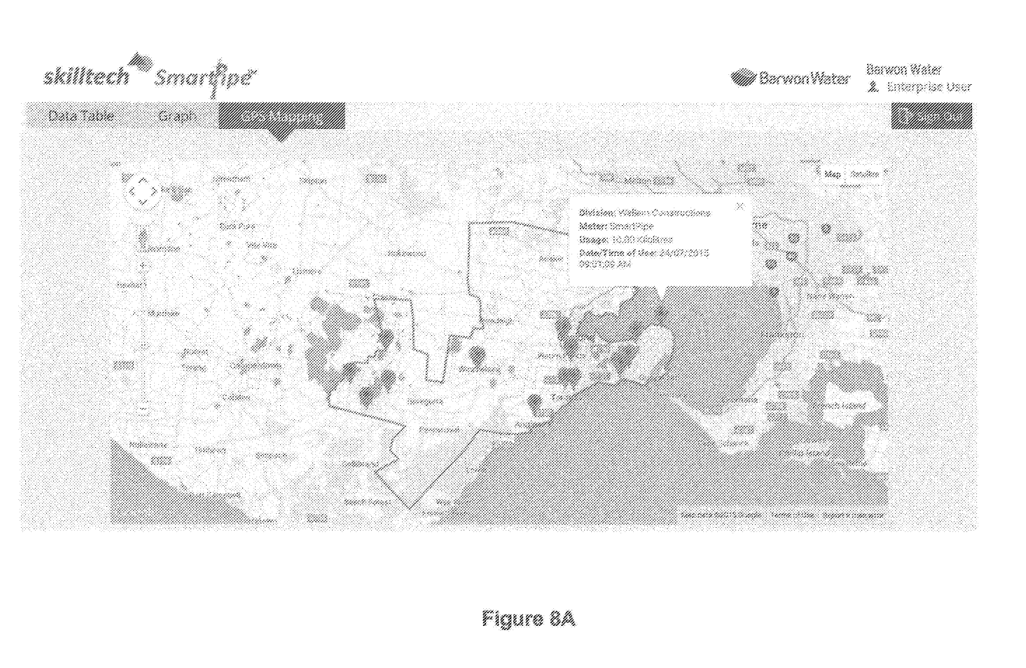

FIGS. 7A to 7D show examples of various reports which have been created using the SmartPipe™ monitoring system. FIG. 7A shows a screen print of a portion of a table displaying daily water usage data for five users (such as water carting contractors and the like) within a selected one month period. FIG. 7B shows a stacked column chart showing the same daily data for the selected one month period. FIG. 7C shows a column chart for a 24 hour period, at 15 minute intervals, and depicting water usage by three different users within this 24 hour period. FIG. 7D shows the same chart as FIG. 7C but with a mouse ‘hovering’ over the right-most column such that the water usage data is displayed. This data includes the name of the registered user, the start date/time of the usage event, the volume of water used (in kilolitres) and the cost of that water.

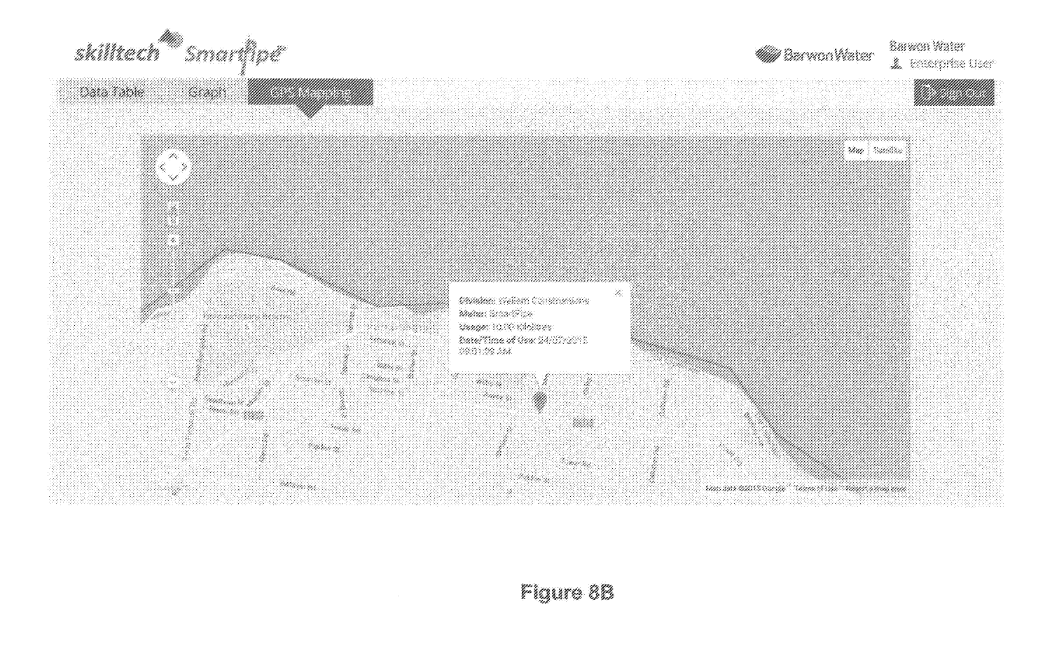

In addition the location of each SmartPipe™ at the time of each water usage event can be displayed on a mapping interface so that the location is visible in a Google Maps style geographical map. FIG. 8A shows an example of such a map depicting the geographical area of Barwon Water, this being the relevant water authority for a geographical area surrounding the city of Geelong in Victoria, Australia. The area is signified in the Figure by a solid line which fences the area. It also includes ‘tear drop’ symbols showing water usage events which occurred within a selected time period. Once again, clicking on the symbol displays relevant data including the user company name, the identity of the SmartPipe™, the volume of water used, and the start date/time of the usage event. FIG. 8B shows a close up view of the area surrounding the specific usage event, which enables the specific hydrant outlet to be visually located on the map.

In an advantageous form of the SmartPipe™ monitoring system, the tear drop symbols may also be colour coded. For example, a water usage event occurring in an authorised geographical area may be coloured green, an event outside the authorised area may be coloured red, and an event occurring in a temporary unauthorised area (such as a low pressure area of the mains network) may be coloured yellow.

In the latter two circumstances an alarm may also be triggered and an SMS message sent to the water authority or to the registered user (who may be the employer of the actual user at the time). Other useful alternatives and extensions would be obvious to persons skilled in the art, and all of them are enabled by the GPS location data provided by the SmartPipe™ intelligent standpipe.

Given the independence of the Watersave SUMS platform, the SmartPipe™ hydrant monitoring system allows water carters to operate across multiple water authorities' boundaries. A centralised monitoring, reporting and invoicing system, provided as part of a ‘managed service’, thereby allows invoices to be raised on behalf of a water authority and reflect only the water drawn from authorised hydrants within that water authority's boundary. The information is then reported monthly, or on any other convenient time internal, and displayed in real-time on the web-based mapping interface. This allows for immediate verification and queries regarding any SmartPipe™ at the time of consumption. The information is also exportable as a CSV file so that it can be imported directly into various billing systems. This removes the need for cumbersome paperwork to be completed on site by the contractor and also later when log book entries would conventionally need to be submitted to each water authority.

Overall, some key advantages of the SmartPipe™ intelligent standpipe and monitoring system may be summarised as follows:

(a) Easy to use SmartPipe™ standpipe with integrated logger which avoids the need to record meter readings
(b) Highly portable equipment and not tied to a specific vehicle.
(c) Removal of paper waste for authorised water carters.
(d) Fill locations displayed on a mapping interface.
(e) Reporting done in real time for ease of administration.
(f) Real time tracking of assets

Although preferred embodiments of the invention are described herein in detail, it will be understood by those skilled in the art that variations may be made thereto without departing from the spirit of the invention or the scope of the appended claims.

1. A portable standpipe for drawing water from a mains water supply, the standpipe including:
an inlet having a first coupling configured to enable the standpipe to be removably connected to a hydrant outlet of the mains water supply;
an outlet having a second coupling configured to enable a water delivery hose to be connected to the standpipe;
a flow meter arranged to measure a volume of water flowing from the inlet to the outlet;
a data logger connected to the flow meter and being configured to record the volume of water measured by the flow meter;
a global positioning system (GPS) module configured to determine the location of the standpipe when the flow meter detects water flow; and
a wireless communication module configured to transmit the recorded volume of water and corresponding GPS location to a central monitoring facility.

2. The portable standpipe as defined in claim 1 wherein the data logger is configured to record the start time of water flow detected by the flow meter, and the wireless communication module is configured to transmit the start time to the central monitoring facility together with the water volume and GPS location.

3. The portable standpipe as defined in claim 1 further including a water flow switch arranged to detect the presence of water flowing through the standpipe, the water flow switch being connected to the data logger to cause an alarm indication in the event that flow is detected by the water flow switch but is not detected by the flow meter.

4. A system for monitoring volumes of water drawn from hydrant outlets in a mains water supply, the system including:
a plurality of portable standpipes defined in claim 1; and
a central monitoring facility configured to receive recorded water volume and GPS location data from each standpipe.

5. The system defined in claim 4 wherein the GPS location data is used to determine the location of the hydrant outlet, within the mains water supply system, from which the water is drawn.

6. The portable standpipe defined in claim 2 further including a water flow switch arranged to detect the presence of water flowing through the standpipe, the water flow switch being connected to the data logger to cause an alarm indication in the event that flow is detected by the water flow switch but is not detected by the flow meter.
